(19) United States
(12) Patent Application Publication
(10) Pub. No.: US 2006/0204626 A1
(43) Pub. Date: Sep. 14, 2006

(54) Method and apparatus for decorating confectioneries

(76) Inventor: Michael L. Talbot, Dublin, OH (US)

Correspondence Address: WINSTON & STRAWN LLP, 1700 K STREET, N.W., WASHINGTON, DC, 20006, US

(21) Appl. No.: 11/073,859

(22) Filed: Mar. 8, 2005

(51) Int. Cl. A23G 3/28

(52) U.S. Cl. 426/383

(57) ABSTRACT

The present invention relates to introducing decorative patterns or particulate inclusions to a portion of edible shells with a spinning device comprising an elongate spindle and an applicator device. Particulates or liquid coating materials are loaded in the applicator device, which is placed adjacent an inner surface of the edible shell or a hollow shell-shaped support, and the spindle and applicator device are spun at a rotational speed sufficient to dispense the particulates or liquid materials out of the applicator device against the inner surface of the shell or support. The present spinning applicator device can apply any kind of particulate inclusion(s) in a portion of a shell, and create visually distinctive patterns of particulates or liquid coating materials that adhere on the surfaces of a shell, and therefore may be used to enhance texture, flavor, and/or appearance of a wide variety of confectionery products.

### FIELD OF INVENTION

The present invention relates to methods and apparatus for providing decorative inclusions or patterns onto a surface of edible confectioneries, in particular edible shells for use as receptacles for holding various foodstuffs. The resultant products are also encompassed by the invention.

### BACKGROUND OF THE INVENTION

Increasingly, there is a consumer demand for composite products formed from different edible materials in complementary combinations. There are different combinations of chocolate shells that contain a different component therein, and many frozen confectionery products such as ice cream and chocolate combinations are known. There are, however, significant production difficulties in introducing new materials to produce interesting new products in a consistent and cost-effective manner.

The need for improved technology for introducing decorative materials into confectioneries designed to receive additional edible components can be seen from the existing manufacturing processes for producing coated or lined confectionery products with decorative appearance. For instance, although attempts have been made for producing chocolate-coated confectionery products with a decorative second layer of coating on top of the first layer of base coating, such attempts have not been always successful, principally because there is only a very short time period within which the second layer must be applied to the first layer in order to achieve satisfactory adherence. The chocolate layers are usually applied in liquid, semi-liquid, or paste form either by spraying, pouring, dipping, or pressing in a cold environment. Generally, this procedure results in the first layer glazing over to form a frost of condensation shortly after application thereof (less than 30 seconds), which prevents the second liquid layer from adhering properly.

U.S. Pat. No. 6,267,073 seeks to solve this problem and discloses chocolate coatings having a marbled appearance formed from two layers of chocolate. The chocolate-coating apparatus and methods of U.S. Pat. No. 6,267,073 are taught only in connection with liquid coatings, rather than being adapted to handle various liquid and solid decorative materials.

U.S. Pat. No. 4,369,200 also discloses a method for producing three-dimensional decorations of a fatty confectionery material on a base confectionery, such as with a nozzle attached to a compressible bag for depositing the decorations. The deposition preferably occurs from a rotary sprayer, which deposits the decoration by use of a plurality of recesses in a mold. The method taught in this reference, however, is limited to decorations using a mold, and only certain fatty confectionery material can be used to form three-dimensional decorations.

Thus, a method and device for providing a variety of decorative materials in a simple, cost-effective, and user-friendly manner are needed. Preferably, such device should be capable of handling both liquid and solid decorative materials, including liquid coating materials and particulate inclusions such as sprinkles and candy pieces, without causing mechanical problems, such as clogging or damaging parts of the machine.

Further, a device that is configured to provide decoration on a surface of hollow edible shells is needed. A simple device capable of introducing various decorative confectionery materials on a surface of hollow shells, such as conical shells, is desired.

### SUMMARY OF THE INVENTION

The present invention provides a method and apparatus for imparting a decorative material on a surface of a hollow edible shell, which may be formed on a support, such as a mold or a packaging sleeve. The hollow edible shell preferably has a substantially conical shape, and comprises chocolate or a fat-based coating material.

The method includes the steps of providing a supply of at least one decorative material to an application zone which disposed inside the shell or a shell support; and centrifugally directing the decorative material out of the application zone with a sufficient velocity so that the material adheres to the inner surface of the shell or support in a desired pattern. The application zone preferable rotates at a speed of about 20 to 200 rpm. If desired, the supply of at least one decorative material to the application zone can be metered to provide only enough decorative material to provide the desired pattern upon a single shell or shell support, or a reservoir can be provided for holding a sufficient supply of the decorative material to decorate a plurality of shells or shell supports.

When the support comprises a mold or a packaging sleeve having a substantially conical shape, the decorative material preferably comprises particulates, a liquid coating material, or both. The particulates may comprise ground nuts, cereals, crisped rice, cookie fines, candy pieces, chocolate chips, confectionery sprinkles, compound chips or chunks, fruit pieces, coconut, or combinations thereof, while the liquid coating material may be a liquid chocolate, liquid caramel, a fat-based edible coating material, a sugar-based edible coating material, or a combination thereof.

In one embodiment, the liquid coating material may be provided on an inner surface of the support so that the method further comprises providing a shell-forming composition on the support such that a shell with a decorative pattern on its outer surface is formed. Alternatively, the liquid coating material may be provided on an inner surface of the shell such that the shell has a decorative pattern on its inner surface. Advantageously, the shell is formed in the shape of a cone from a chocolate or a fat-based coating material.

The apparatus comprises a rotatable elongated spindle operatively associated with an applicator device for containing a supply of the decorative material; and a positioning device operatively associated with the applicator device and spindle to direct decorative material at an inner surface of the shell or a shell support. The spindle and applicator device preferably rotate at a speed sufficient to dispense the decorative material out of the applicator device and onto a portion of the inner surface of the shell or the support, and the applicator device is preferably configured and dimensioned to fit entirely within the hollow edible shell.

The applicator device may be configured to rotate with the spindle but is detachable therefrom. The applicator device preferably has a diameter of about 10 to 60 mm and a rotational speed of about 20 to 200 rpm. For ease of manufacture and use, a tube provides a metered supply of decorative material into the applicator device. As mentioned, a reservoir can be provided for holding a quantity of the decorative material and a filling device used for providing a metered supply of the decorative material into the applicator device from the reservoir.

Hence, the present method may be used to impart particulate inclusions on an edible shell, or to create decorative patterns on a surface of a shell. Various shapes of hollow shells, such as a substantially conical shape, may be decorated with the present method. After the shell is decorated, a confectionery filling may be optionally provided in the shell.

### BRIEF DESCRIPTION OF THE DRAWINGS

Preferred embodiments of the invention will now be described, by way of example only, with reference to the accompanying drawings in which:

FIG. 1 is an illustration of the application of particulate inclusions in a portion of a cone-shaped shell using the spinning applicator device of the present invention;

FIG. 2 is an illustration of the application of liquid decorative patterns to a portion of an inner surface of a cone-shaped support using the present device; and

FIGS. 3A-3B are examples of cones decorated according to the present method.

### DETAILED DESCRIPTION OF THE PREFERRED EMBODIMENTS

The present invention provides a surprising and unexpected method and device for introducing various decorative materials to a surface of confectioneries. The present method and device may be used to introduce any solid particulates, such as ground nuts or candy pieces, as well as liquid/semi-liquid materials, such as liquid chocolate or caramel, into any kind of hollow-shaped confectionery items. Advantageously, the present invention may be used to introduce particulate inclusions and/or liquid materials to chocolate or fat-based compound shells and to shells made from various liquid shell-forming materials.

In the following description, “decorative material” refers to any solid or liquid material that can be introduced on an inner or outer surface of a hollow edible shell. “Liquid coating material” refers to a liquid material that can be used with the present applicator device to create decorative patterns on a surface of a shell and to substantially adhere thereto. Some small portion, e.g., less than about 10 weight percent of the material may drip or flow away from the desired decorative pattern due to, for example, gravity or further processing. “Shell-forming material” refers to a material that is liquid when dispensed onto a mold or packaging support, but solidifies to form a solid, but hollow, shell. A shell-forming material may be the same as the liquid coating material, and therefore may be referred to as such.

Where chocolate is used in the liquid coating or shell-forming material, the chocolate may be ordinary or real chocolate according to accepted regulations, or it may be a fat-containing confectionery compound material containing sugar, milk-derived components, and fat and solids from vegetable or cocoa sources in differing proportions. The fat-containing material may be a chocolate substitute containing one or more of the following: cocoa butter replacements, stearines, coconut oil, palm oil, butter or any mixture thereof; nut pastes such as peanut butter and fat; praline; confectioner's coatings used for covering cakes usually comprising chocolate analogues with cocoa butter replaced by a cheaper non-tempering fat; or “Caramac” sold by Nestle comprising non-cocoa butter fats, sugar and milk.

The term “compound coating” refers to a coating based on fats other than cocoa butter, including milk fat and vegetable fats such as coconut oil, palm kernel oil, soybean oil, or a blend of such oils. The terms “confectionery shell” and “confectionery coating material” refer to shells and coating materials that are made of edible materials other than real chocolate or fat-based coating materials. Such “confectionery shell” or “confectionery coating material” includes one or more of: sugar-based confections such as nougat, marshmallow, caramel, fudge, fondant crème, high-boiled sugar, gelatin, pectin-based jelly, and Turkish delight, or any combination thereof. Sugar may be partially or wholly replaced in such confectionery coating materials with, for example, starch, fiber, protein, or non-sugar sweeteners such as polypols, polydextrose, acesulfame K, sucralose or aspartame, or any combination thereof. The “confectionery shell” can include or be a wafer in any desired shape that contains a hollow portion to contain a plurality of inclusions and a filling in the hollow portion. The term “rundown” is used to describe the amount of liquid coating or shell-forming material that runs down to the bottom of the shell before it is set and solidified. The terms “packaging sleeve” and “packaging support” are used interchangeably.

Although a cone-shaped shell is most often described by way of example, it will be appreciated that the invention can alternatively be used in combination with various shapes of hollow shells, including the shapes of a bowl, a cup, a ball, a cylinder, a pyramid, a frustum, a flower, and an animal, as well as shapes that are substantially in these forms, i.e., recognizable as the noted shapes but deviating in some way from a true shape, e.g., a ball with protrusions or depressions in the surface thereof. A preferred confectionery shell is a substantially or entirely cone-shaped shell, or a tapered cone made from a liquid shell-forming material.

Similarly, while ice cream is often mentioned as a suitable filling for the shell, any other ice or frozen confectionery filling materials such as frozen yogurt, sorbet or other water ice, or non-frozen confectionery materials such as marshmallow, peanut butter, fudge, cream or jelly may be used. Thus, the ordinary-skilled artisan will be able to readily select from the wide variety of combinations available for creating filled shell confection novelties in accordance with the invention described herein.

The term “substantially,” as used herein to refer to a shape, is intended to include variations from true shape, e.g., a cone, that do not affect the overall appearance or function of the confectionery product.

The term “about,” as used herein, should generally be understood to refer to both numbers in a range of numerals. Moreover, all numerical ranges herein should be understood to include each whole integer within the range.

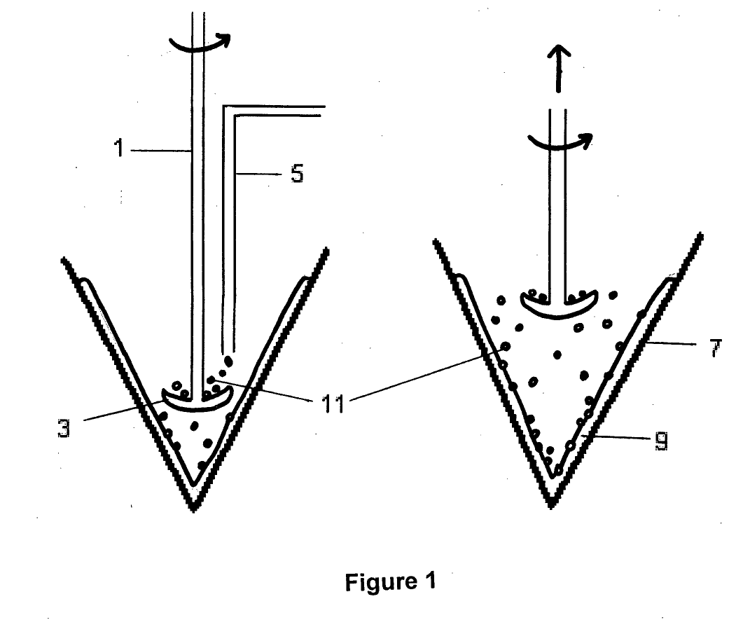

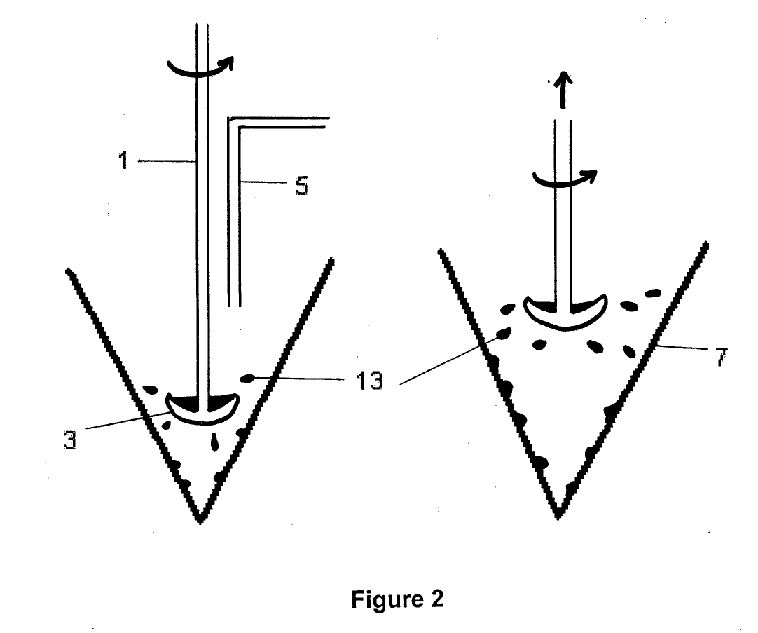

In one embodiment, the present invention provides introduction of decorative materials, such as particulate inclusions or liquid coating materials, onto shells made with chocolate, fat-based compound coating or any other liquid coating materials. As shown in FIGS. 1-2, a spinning decoration applicator apparatus comprising an applicator cup 3 attached to an end of an elongate spindle 1 may be used. The cup is supplied with a decorative material, is placed inside a shell-shaped support 7 or shell 9 by a suitable positioning means, and the spindle is spun at a desired rotational speed to provide a pre-selected pattern of decorative material to an inner surface of the support or shell, thus also spinning the cup that is operatively associated with the spindle. The applicator device and spindle can be attached in any suitable way, e.g., by being integrally formed, by being attached by adhesive(s) or welding, etc. As the spindle and cup are spun, the decorative material contained in the cup is centrifugally forced off the applicator device and is applied against an inner wall of the support or shell. The inner wall may form only a portion of the support or shell, or the entire support or shell, to provide decorative material to only a portion, or to the entire, surface to form the desired pattern.

The applicator device may be designed such that it can be releasably detached from the spindle. Such design allows the use of applicator devices of different sizes or designs with one spindle. The size of the applicator device may vary depending on the size of the shell to be decorated. To prepare a typical cone-shaped shell with decorative material on its surface, the applicator device can be a cup with a diameter of about 10-60 mm. The rotational speed and application time of the device may also be adjusted as desired to facilitate formation of the desired pattern. For example, a rotational speed of about 20 to 200 rpm may typically be used depending on the type of the decorative material, although highly viscous material may require correspondingly higher rotational speeds to form similar patterns as will be readily determined by those of ordinary skill in the art.

Importantly, the applicator device can be formed in a variety of shapes so long as it can direct decorative material onto the shell or support. The applicator device can be a cup, a plurality of fixed or movable nozzles or jets, or simply holes in the spindle or other supply line to direct coating material onto the shell or support.

Referring to FIG. 1, the applicator cup 3 attached to the spindle 1 is filled with an amount of particulates 11 and then is lowered into a cone-shaped shell 9 formed on a support 7, which may be a mold or a packaging sleeve. In FIG. 1 as shown, the spindle 1 is then rotated at a speed sufficient to cause the particulates 11 to fly off the cup 3 against the wall of the shell 9, to which the particulates 11 adhere and/or become partially embedded. Preferably, the particulates are sufficiently sticky or sufficiently embedded to facilitate adherence to the inner wall of the shell 9. The spindle 1 and the attached cup 3 may be moved vertically, or in any direction, i.e., at an angle from the vertical, to ensure even application of the particulates or to create a desired inclusion pattern. For instance, the applicator cup 3 may at first be placed at the bottom of the shell 9 formed inside the support 7 and then raised as it is spun in order to achieve even coverage over the entire inner surface of the shell. Alternatively, e.g., the spindle may be angled 10 degrees from the vertical and rotated to provide a more vertically oriented pattern without raising or lowering the applicator cup during rotation.

After application, the spindle 1 and the cup 3 are withdrawn from the shell 9. In a preferred embodiment, this is typically done after halting the rotation so as not to waste or create a mess of any remaining decorative material in the applicator device. When the shell is later filled with ice cream or another confectionery filling after the application of the particulate inclusions, the pressure of the filling helps to further embed the inclusions into the cone or adhere the inclusions to the inner surface thereof. If desired, a second layer of the same or a different shell-forming material may be applied over the particulate inclusions, e.g., such that the particulates are completely covered with the coating. The process may be repeated any number of times as desired to create a thick shell or a multi-layered shell with different shell material layers and particulate inclusions.

Several different methods can be used to feed the particulates or liquid coating material onto the applicator device. For instance, as shown in FIG. 1, a supplying pipe or tube 5 that runs parallel to the spindle 1 may be used to supply the cup 3 with particulates between or even during applications. The tube may be connected to a reservoir of the decorative material, and may be designed to dispense a metered amount of the decorative material at a certain time interval. It may be withdrawn during the decoration application such as not to impede the movement of the applicator device. Alternatively, a reservoir or a container filled with particulates may be utilized, and the applicator cup can be refilled with particulates or liquid coating material by being dipped into the reservoir after each cycle of spinning inside a shell. In another embodiment (not shown), a continuous supply or a metered supply of decorative material can be delivered to the applicator cup 3 by a supply line that can be inside the spindle 1.

Non-limiting examples of particulate inclusions that can be used according to the present invention include ground nuts, cereals, crisped rice, cookie fines, candy pieces, chocolate chips, confectionery sprinkles, compound chips or chunks, fruit pieces, and coconut. Combinations of different particulates may be used. Where the filling to be added to the shell is an ice confection such as ice cream, frozen yogurt, sorbet or water ice, the particulates may be pre-coated or pre-treated to provide a moisture barrier, such that they are more resistant to moisture uptake even when they come in contact with the ice confectionery filling, to inhibit or prevent moisture migration into moisture-sensitive inclusions.

It will be appreciated that the present method can be used to apply edible particulates in combination with any shell-forming material, as long as the shell-forming material remains sufficiently soft or sticky, or the particulates are sufficiently soft or sticky, that the particulates will adhere to the inner surface of the shell or shell-forming material. For example, in addition to chocolate- or fat-based shells, the present method can be used to apply particulate inclusions on shell-forming materials comprising melted nougat or marshmallow, fondant crème, caramel, fudge, high-boiled sugar, gelatin, pectin-based jelly, dried honey, Turkish delight, or any other edible material to which particulates can adhere, or any combination thereof.

In another embodiment, the present invention provides decorative patterns on the inside, and optionally even on the outside, surfaces of hollow shells by applying a liquid coating material with the present spinning applicator device.

Any material may be used as the liquid coating material, as long as it solidifies at room temperature, i.e., 20° C., or when frozen if intended for frozen confectionery products. Thus, any of a wide variety of materials, including real chocolate, lower-fat or high-fat compound coating materials, sugar-based materials, as well as coating materials made with non-sugar sweetener, starch, fiber or protein may be utilized.

The liquid coating material may further comprise an emulsifier for reducing viscosity and/or yield value, which may comprise lecithin, ammonium phosphatide, polyglyceryl polyricinoleate (PGPR), or citric acid ester of mono-glycerides. One or more emulsifiers can be used in a preferred amount of about 0.05 to 1% by weight of the coating composition. Various natural or artificial sweeteners may be included in the coating material, including sugar, dried honey, corn syrup solids, lactose, anhydrous dextrose, malitol, xylitol, lactitol, mannitol, polydextrose, acesulfame K, sucralose and aspartame, and any combination thereof, in a preferred amount of about 25 to 60% by weight.

Non-limiting examples of liquid coating materials include liquid chocolate, liquid caramel, vegetable fat-based compound coatings, and sugar-based confectionery coatings comprising nougat, marshmallow, caramel, fudge, fondant crème, high-boiled sugar, gelatin, pectin-based jelly and Turkish delight, and any combination thereof.

The liquid coating material may be the same as or different from the material used to form the shell. The coating material and the shell-forming material may comprise the same ingredients and differ only in color, or they may have different ingredients and different flavors and/or textures. Preferably, the coating material has a color that is different, or visually contrasting, from that of the shell-forming material such that the decorative patterns are distinctly visible and visually appealing. In another embodiment, the pattern has a different texture compared to the shell to provide a surprise to the consumer as the hidden pattern within the shell is eaten, which then reveals the texturally different pattern as the shell is consumed.

To produce an edible shell with decorative patterns on its outer surface, the liquid coating material may be applied to the inner surface of a mold or packaging support upon which the shell is formed. For example, where a chocolate cone is made by the conventional forming technique, the present method first forms decorative patterns on the inside surface of the cone mold. A chocolate shell-forming composition is then dispensed into the mold, producing a chocolate cone with decorative patterns on its outer surface. Similarly, when a shell is formed on a packaging sleeve or support, patterns are first formed on an inner surface of the packaging sleeve, and then a shell-forming composition is dispensed onto the packaging sleeve to produce a shell with decorative patterns on its outer surface.

Referring to FIG. 2, the applicator cup 3 is filled with an amount of a liquid coating material 13 and is lowered into a support 7, which may be a mold or a packaging support, by the spindle 1. The spindle 1 is then rotated at a speed sufficient to cause the coating material 13 to fly off the cup 3 onto the support 7, thus creating a pattern on the inside surface of the support. The spindle 1 and the attached cup 3 may be moved vertically, or in any direction as noted above, during application to ensure even application of the coating material over the entire inner surface of the mold or packaging sleeve, or preferably to create a desired pattern. After application, the spindle 1 and the cup 3 are withdrawn from the support 7, and an edible shell is formed on the support by any known shell-forming process.

For a subsequent decoration application, the applicator cup may be refilled with a supply of coating material by any suitable means. For example, a pipe or tube 5 may be used to supply the liquid coating material onto the cup between applications as shown in FIG. 2, or a reservoir or a container filled with the coating material may be utilized such that the applicator cup is refilled by being dipped into the reservoir after each cycle of application.

After the pattern-decorated shell is cooled and set, the shell may optionally be filled with a confectionery filling or an ice confectionery filling material. In one embodiment, when the shell is removed from the mold or the packaging sleeve, the consumer sees the decorative pattern on the outer surface of the shell.

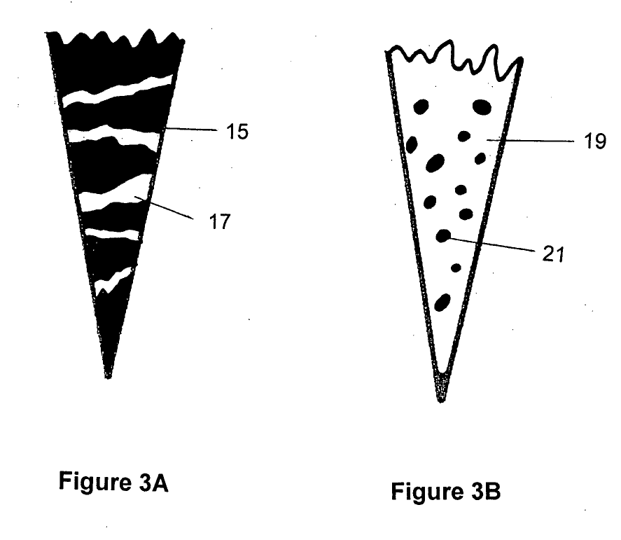

Examples of shells decorated with the present method are shown in FIG. 3A-3B. FIG. 3A shows a cone having a decorative pattern on its outer surface thereof. The pattern is a milk chocolate shower cone 15 decorated with white chocolate line pattern 17, and FIG. 3B shows a shower cone 19 made with white chocolate flavored compound coating and decorated with dark brown speckles 21.

In one preferred embodiment, however, the present invention is used to create decorative patterns on the inner surface of a shell by applying a liquid coating material after the shell is formed. This can be in addition to any coating patterns on the outside surface. In this embodiment, a liquid coating material is applied onto the inside surface of a shell in the same manner as described above, producing a shell showing patterns on its inner surface. Such inside decoration may be especially desirable when the final product is an empty shell that consumers can fill with fillings of their choice, or a shell that is only partially filled. Even if the shell is entirely filled, the decorative pattern can be visible from above or the sides as a consumer eats the confectionery product, and can provide a desired texture/flavor/appearance difference from the shell and/or confectionery filling to provide an unexpected surprise as the product is consumed, e.g., like eating a box of chocolates filled with different unknown inclusions. For example, a box of products can be prepared with shells having multiple types of inclusions in the same box to provide a desirable surprise discovered only upon consumption. Any of the above-noted edible materials may be used for the filling, including cream, candies, frozen confections and pieces of fruit. Typically, the filling is capable of flowing into the hollow portion of the shell at room temperature or above. It will also be appreciated that the inner surface of any solid hollow shell may be decorated by the present method and device. For example, the present invention may be used to create patterns on the inner surface of a conventional waffle cone.

The exact pattern formed according to the present invention will depend on a number of factors, including the rotational speed of the spindle and the cup, the consistency or viscosity of the coating material, and the shape of the mold or packaging sleeve. For example, a rotational speed of, for example, only about 20 to 40 rpm would form line patterns, while a higher rotational speed of about 50-to 200 rpm would result in the formation of speckles rather than lines. Thus, unique patterns or certain designs may be formed by manipulating the density of the coating material and/or the rotation speed of the spinning applicator device. These will be readily determined by those of ordinary skill in the art through routine experimentation and with reference to the present application.

A certain amount of rundown may occur and cause distortion of the pattern if the liquid coating material does not set immediately upon application. Such distortion of the pattern is not an undesirable feature and can result in an unique appearance. A coating material with low rundown can be used where lines or speckles with defined shapes are desired, whereas a high-rundown coating material can be used to create patterns with less shape definition.

Further, liquid coating materials and particulate inclusions can be used in combination according to the present invention to produce shells with particulate inclusions embedded and showing decorative patterns on the outer surface.

The end results of the present invention are confectionery products comprising a shell with distinct texture, visual, or flavor patterns using various particulate inclusions or liquid coating material to form a decorative pattern, that may optionally be filled with a confectionery filling and suitable decorative or complementary toppings. Therefore, the present invention can be used to alter or improve the appearance as well as the textural, nutritional and/or flavor properties of various confectionery products.

As the present decorative method and device can be used in combination with different shell-forming processes, manufacturers will appreciate the versatility and operational ease of the present device as well as the enhanced competitive advantage afforded by the invention. Consumers will appreciate the introduction of a wide variety of novel products enabled by the present invention.

### EXAMPLES

The following examples further illustrate some of the preferred embodiments of the present application. It should be noted that, although described with reference to specific examples, the invention will be appreciated by those of ordinary skill in the art to occur in many other forms and embodiments.

### Example 1

### Real Milk Chocolate-Based Liquid Coating Material (% by Weight)

| | |
|---|---|
| Sugar | 44.3 |
| Cocoa liquor | 15 |
| Cocoa butter | 19.5 |
| Whole milk powder | 20 |
| Anhydrous butterfat | 1 |
| Vanillin | 0.05 |
| Lecithin | 0.15 |

An exemplary liquid coating material including chocolate for use according to the invention was prepared according to the above proportions so as to provide sufficient viscosity and thickening properties so that the liquid coating material could adhere to an inner surface of a confectionery product or a support to which it is applied and solidify thereto sufficiently to remain substantially in the pattern in which it is applied.

### Example 2

### Vegetable Fat-Based Liquid Coating Material (% by Weight)

| | |
|---|---|
| Sugar | 44.5 |
| Cocoa powder | 9 |
| Coconut oil | 28.3 |
| Whole milk powder | 18 |
| Vanillin | 0.05 |
| Lecithin | 0.15 |

A second exemplary liquid coating material including a chocolate substitute for use according to the invention was prepared according to the above proportions. This liquid coating material can be formed so as to provide sufficient viscosity and thickening properties so that the liquid coating material could adhere to an inner surface of a confectionery product or a support to which it is applied and solidify thereto sufficiently to remain substantially in the pattern in which it is applied.

### Example 3

### Milk Chocolate Shower Cone Containing Small Pieces of Chopped Almonds

A small cone is made with 7 grams of real milk chocolate on a cone-shaped packaging sleeve, for example, according to the shower method disclosed in co-pending U.S. patent application Ser. No. 10/800,222. 0.8 grams of finely chopped almonds are placed on an applicator device, and the device is lowered into the cone and spun at around 100-200 rpm, forcing the almond particulates to fly out of the applicator device into the walls of the cone. The applicator device is then withdrawn from the cone.

After the particulate application, the cone contains approximately 10% by weight of almonds. The cone is then filled with 14 grams of ice cream or water ice product. The top of the confectionery cone product may be decorated with more ice cream or water ice of the same or a different color, and optionally sauce, sprinkles, or both. It may also be sprinkled with more particulates, such as almonds, another type of nuts, or chocolate inclusions such as chocolate chips.

The incorporation of the particulate inclusions adds further complexity to the flavor of the cone product and imparts a crunchy texture.

### Example 4

### White Chocolate Shower Cone Containing Chocolate Cookie Fines

An ice cream or water ice cone is made according to Example 3 above, but with white chocolate containing 35% by weight of fat, and the particulate inclusions are chocolate cookie fines. The consumer experiences a delightfully more varied flavor and crunchy texture when eating the ice cream cone.

### Example 5

### Milk Chocolate Cone Decorated with Irregular Horizontal Lines of White Chocolate

0.8 grams of white chocolate coating (with approximately 38% fat by weight) is placed in the applicator cup. The applicator cup is lowered into an empty mini-cone packaging sleeve and spun at about 20-40 rpm, causing the white chocolate coating to fly out of the cup onto an inner surface of the sleeve to form irregular horizontal lines on the inner surface of the sleeve. The applicator cup is then withdrawn.

About 7 grams of real milk chocolate (e.g., about 34% fat) is then showered onto the mini-cone sleeve, and the sleeve is then filled with vanilla ice cream. The top of the ice cream may be decorated with more ice cream, cream, sauce, and/or sprinkled with conventional topping particulates, such as almond pieces or chocolate chips. After freezing, the cone sleeve may be removed to reveal a milk chocolate cone decorated with irregular horizontal lines of white chocolate.

### Example 6

### White Vegetable Fat-Based Compound Cone Decorated with Speckles of Dark Brown Vegetable Fat-Based Compound Coating

A cone is made as in Example 5, except that the cone is made with a white compound coating (with 35% fat) and the decorative speckles are formed with a dark cocoa-flavored vegetable fat-based compound coating (e.g., with approximately 45% fat). The applicator is spun at a higher speed of about 50-100 rpm. The higher fat content of the dark compound coating, and the higher revolution speed of the applicator, cause the formation of speckles rather than lines on the inner surface of the cone sleeve. After freezing, removal of the cone sleeve reveals a white cone decorated with dark brown speckles.

Although preferred embodiments of the invention have been described in the foregoing description, it will be understood that the invention is not limited to the specific embodiments disclosed herein but is capable of numerous modifications by one of ordinary skill in the art. It will be understood that the materials used and the mechanical and chemical details may be slightly different or modified from the descriptions herein without departing from the methods and apparatuses disclosed and taught by the present invention.

What is claimed is:

1. A method for providing decorative material upon a surface of a hollow edible shell or shell support which comprises:
providing a supply of at least one decorative material to an application zone which is disposed inside the shell or a shell support; and
centrifugally directing the decorative material out of the application zone with a sufficient velocity so that the material adheres to the inner surface of the shell or support in a desired pattern.

2. The method of claim 1, wherein the application zone rotates at a speed of about 20 to 200 rpm.

3. The method of claim 1, wherein the supply to the application zone is metered to provide only enough decorative material to provide the desired pattern upon a single shell or shell support.

4. The method of claim 1, which further comprises providing a reservoir for holding a sufficient supply of the decorative material to decorate a plurality of shells or shell supports.

5. The method of claim 1, wherein the support comprises a mold or a packaging sleeve having a substantially conical shape and the decorative material comprises particulates, a liquid coating material, or both.

6. The method of claim 5, wherein the decorative material comprises particulates selected to comprise ground nuts, cereals, crisped rice, cookie fines, candy pieces, chocolate chips, confectionery sprinkles, compound chips or chunks, fruit pieces, coconut, or combinations thereof.

7. The method of claim 5, wherein the decorative material comprises a liquid coating material which is provided on an inner surface of the support and the method further comprises providing a shell-forming composition on the support such that a shell with a decorative pattern on its outer surface is formed.

8. The method of claim 7, wherein the liquid coating material comprises liquid chocolate, liquid caramel, a fat-based edible coating material, a sugar-based edible coating material, or a combination thereof.

9. The method of claim 1, wherein the decorative material comprises a liquid coating material which is provided on an inner surface of the shell such that the shell has a decorative pattern on its inner surface.

10. The method of claim 1, which further comprises forming the shell in the shape of a cone from a chocolate or a fat-based coating material.

11. The method of claim 10, which further comprises providing a confectionery filling in the shell after the decorative material is provided in the shell.

12. An apparatus for imparting a decorative material on a hollow edible shell or shell support, comprising:
a rotatable elongated spindle operatively associated with an applicator device for containing a supply of the decorative material; and
a positioning device operatively associated with the applicator device and spindle to direct decorative material at an inner surface of the shell or a shell support,
wherein the spindle and applicator device rotate at a speed sufficient to dispense the decorative material out of the applicator device and onto a portion of the inner surface of the shell or the support, and wherein the applicator device is configured and dimensioned to fit entirely within the hollow edible shell.

13. The apparatus of claim 12, wherein the applicator device is configured to rotate with the spindle but is detachable therefrom.

14. The apparatus of claim 12, wherein the applicator device has a diameter of about 10 to 60 mm and the rotational speed of the applicator device is about 20 to 200 rpm.

15. The apparatus of claim 12, further comprising a tube for providing a metered supply of decorative material into the applicator device.

16. The apparatus of claim 12, further comprising a reservoir for holding a quantity of the decorative material and a filling device for providing a metered supply of the decorative material into the applicator device from the reservoir.

17. The apparatus of claim 12, wherein the support is a mold or a packaging sleeve having a substantially conical shape and the decorative material comprises particulates, a liquid coating material, or both.

18. The apparatus of claim 17, wherein the decorative material is formed from particulates which comprise ground nuts, cereals, crisped rice, cookie fines, candy pieces, chocolate chips, confectionery sprinkles, compound chips or chunks, fruit pieces, coconut, or a combination thereof.

19. The apparatus of claim 17, wherein the decorative material is formed from liquid coating material which comprises liquid chocolate, liquid caramel, a fat-based edible coating material, a sugar-based edible coating material, or a combination thereof.
